(19) United States
(12) Patent Application Publication
(10) Pub. No.: US 2024/0161207 A1
(43) Pub. Date: May 16, 2024

(54) SYSTEM AND METHOD FOR CREATING AND USING A LOCATION-BASED AUGMENTED REALITY COMMUNITY PLATFORM

(71) Applicant: Mortal Technology, LLC, Sacramento, CA (US)

(72) Inventor: Jacob SAX, Sacramento, CA (US)

(21) Appl. No.: 18/509,482

(22) Filed: Nov. 15, 2023

Related U.S. Application Data
(60) Provisional application No. 63/425,738, filed on Nov. 16, 2022.

(51) Int. Cl. G06Q 50/00

(52) U.S. Cl. CPC G06Q 50/01; G06Q 2230/00

(57) ABSTRACT

A system and method for creating and using a location-based augmented reality community platform is disclosed. An example embodiment is configured to: establish, by use of a data processor and a data network, a data connection with a client device of at least one user platform; determine a region associated with a particular geographical location; enable the client device to create a proposed community associated with the region, the community enabling interaction with content posted to the community by any of a plurality of networked client devices; provide user interface tools enabling the plurality of networked client devices to vote on whether the proposed community should be adopted; enable the client device to post content to the adopted community associated with the region, the content posted to the community being viewable only to client devices having access to the community; and anchor the content to a specific geographical location corresponding to a geographical location where the client device was located when the content was posted.

### PRIORITY PATENT APPLICATION

This non-provisional patent application draws priority from U.S. provisional patent application Ser. No. 63/425,738; filed Nov. 16, 2022. The entire disclosure of the referenced patent application is considered part of the disclosure of the present application and is hereby incorporated by reference herein in its entirety.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2022-2023 Mortal Technology, LLC, All Rights Reserved.

### TECHNICAL FIELD

This patent application relates to computer-implemented data processing and software systems, according to one embodiment, and more specifically to a system and method for creating and using a location-based augmented reality community platform.

### BACKGROUND

Internet-connected mobile devices enable users to obtain information immediately wherever they may be currently located. For example, a user often searches for information on nearby restaurants or interest-related information by using Internet-connected mobile devices. In this case, various map applications can be used to display the information searched by the user on a map. In this manner, the user can associate the searched-for information with a geographical location. In a typical map application, the current location of the user and the searched location or place may be displayed together and may be displayed by different icons depending on the features of the place searched. However, the typical map application is still limited to simply displaying a location searched based on a search term. Moreover, there is no robust capability in conventional solutions to engage with other users who may be interested in content associated with similar locations.

### SUMMARY

In various example embodiments described herein, a system and method for creating and using a location-based augmented reality community platform are disclosed. In the various example embodiments described herein, a computer-implemented tool or software application (app) as part of a location-based community system is described to automate and realize a metaverse social media platform that leverages Augmented Reality (AR) and Geolocation to allow users the option to create Posts of three-dimensional (3D) Content at geographical coordinates and submit the Posts to a Community focused around a shared interest. As described in more detail herein, a computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, consumer electronic devices, or any other type of computing, data processing, communication, networking, or electronic system. The example embodiments also may be used with AR glasses, or other devices capable of projecting AR, VR (Virtual Reality), or MR (Mixed Reality) experiences, e.g. AR headset hardware, VR headset hardware, MR headset hardware, etc.

In various example embodiments described herein, the location-based community system provides a set of data structures and computer-implemented processes to facilitate creation and use of a location-based augmented reality community platform. To see what other users have posted, the user creates or selects a Filter Set that determines what content will be presented to the user. A Filter Set includes one or more inclusion criteria (e.g., a subset of accessible Communities) and one or more exclusion criteria. Communities can belong to Regions, a geographical fence around a city, county, state, country, or similar entities. Filter Sets can be easily shared to encourage alternate points of view. Once a user has selected a Filter Set, they can use their client device's camera to see the Posts included in the Filter Set displayed using augmented reality. Additionally, accessible content may be displayed or communicated to a user in other formats, if the content supports it, e.g., a two-dimensional (2D) representation, a textual representation, an auditory representation, etc. A map is also available to help users navigate to Posts. Users can choose to verify themselves as a Verified Resident of a Region, meaning to signify they are a resident of or have an interest in the Region, or at least are frequently physically present there, to foster trust in the community. Communities can offer other forms of content such as a live-chat system. Various example embodiments of the location-based community system are described in detail below.

### BRIEF DESCRIPTION OF THE DRAWINGS

The various embodiments are illustrated by way of example, and not by way of limitation, in the figures of the accompanying drawings in which:

FIG. 1 illustrates an example embodiment of a networked system in which various embodiments may operate;

FIGS. 2 through 16 illustrate example screenshots of a mobile device user interface of an example embodiment;

FIGS. 17 through 18 illustrate processing flow diagrams that show an example embodiment of an augmented reality process flow as described herein;

FIGS. 19 through 21 illustrate filter structures used in an example embodiment;

FIG. 22 illustrates region structures used in an example embodiment;

FIG. 23 illustrates another example embodiment of a networked system in which various embodiments may operate;

FIG. 24 illustrates a processing flow diagram that illustrates an example embodiment of a method as described herein; and

FIG. 25 shows a diagrammatic representation of a machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In various example embodiments described herein, a system and method for creating and using a location-based augmented reality community platform are disclosed. In the various example embodiments described herein, a computer-implemented tool or software application (app) as part of a location-based community system is described to automate and realize a metaverse social media platform that leverages Augmented Reality (AR) and Geolocation to allow users to create Posts of three-dimensional (3D) Content at geographical coordinates and submit the posts to a Community focused around a shared interest. As described in more detail herein, a computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, consumer electronic devices, or any other type of computing, data processing, communication, networking, or electronic system. The example embodiments also may be used with AR glasses, or other devices capable of projecting AR, VR (Virtual Reality), or MR (Mixed Reality) experiences, e.g. AR headset hardware, VR headset hardware, MR headset hardware, etc.

In various example embodiments described herein, the location-based community system provides a set of data structures and computer-implemented processes to facilitate creation and use of a location-based community platform that utilizes augmented reality. To see what other users have posted, the user selects a Filter Set that determines what content will be presented to the user. A Filter Set includes one or more inclusion criteria (e.g., a subset of accessible Communities) and one or more exclusion criteria. Communities can belong to Regions, a geographical fence around a city, county, state, country, or similar entities. Filter Sets can be easily shared to encourage alternate points of view. Once a user has selected a Filter Set, they can use their client device's camera to see the Posts included in the Filter Set displayed using augmented reality. Additionally, accessible content may be displayed or communicated to a user in other formats, if the content supports it, e.g., a two-dimensional (2D) representation, a textual representation, an auditory representation, etc. A map is also available to help users navigate to Posts. Users can choose to verify themselves as a Verified Resident of a Region, meaning to signify they are a resident of or have an interest in the Region, or at least are frequently physically present there, to foster trust in the community.

In an example embodiment, systems and methods can be implemented to create and use a community platform with content that can be created, customized, interacted with, and shared to an accessible Community by associating a geolocation with the content. The content can be displayed in augmented reality either manually or automatically on a client device when the client device is in proximity of the geolocation. The content can comprise text, images, videos, sound recordings, 3D photos, 3D videos, and/or various interactive or non-interactive 3D entities, characters, and scenes .

Community accessibility is determined by the accessible Regions for the client device. The accessible Regions are determined by using the client device's geographical coordinates to determine which primary geographical entities (Regions) exist at the client device's location. Each Region has at least one Community and more Communities can be added to a Region, one manner being that a Community may be proposed and voted upon to be created by client devices in that Region. One Filter Set inclusion criteria is choosing a subset of these accessible Communities from which content is included. Various example embodiments of the location-based community system are described in detail below.

### Key Terminology and Features

### Augmented Reality

Augmented Reality is an interactive experience that combines the real world and computer-generated content through superimposing 3D content over a camera feed, mimicking physical coexistence with the 3D content.

### Geolocation

Geolocation is the process or technique of identifying the geographical location of a person or device by means of digital information processed, in some cases, via the interne.

### Content

Content is the overarching label for all types of digital data users can use to create a Post. This digital data can include content such as text, photos, videos, audio, 3D photos, 3D videos, and any various 3D objects or scenes (e.g., collections of 3D objects).

### Regions

A Region is a hierarchical geographical location to which Communities and Filter Sets belong (e.g., Country>State>County>City>Neighborhood). For example, a hierarchy of Regions could be the Regions: “US”, “California”, “Sacramento County”, “Sacramento”, “Midtown”.

### Communities

A Community is an entity that belongs to a Region, to which Posts and Community Chat Messages belong. Communities, by default, are only accessible to those physically present in the Region. New Communities as well as changes to existing Communities can be proposed by Verified Residents (defined below). Verified Residents can vote on these proposed new Communities to determine if the proposed Communities should be adopted or not. Communities also include a chat-feed where client devices can communicate messages immediately to all client devices in the same Region (who have access to the Community). Private Communities can also be created that are managed by the creators and can be configured for public viewing and participation or not. For example, a Community could be added called “Coffee” that is about all the local coffee shops and tips for brewing better coffee. Communities in different Regions can be Linked to create a Linked Community where client devices can communicate about similar topics from different Regions, e.g., the Community “Coffee” in the New York Region could link with the Community “Coffee” in the San Francisco Region, enabling client devices to intentionally create links with communities of people who do not live near them.

### Posts

Posts are one or more pieces or items of Content that are submitted to a Community for viewing using augmented reality or other rendering method. Some of the types of content include text, photos, videos, audio, 3D photos 3D videos, 3D objects, 3D characters, or 3D scenes. Posts can be liked, disliked, commented on, shared, reported, hidden, and pinned. Content can be submitted using multiple viewing configurations: (1) Content can be posted using Geo Tracking: associating a particular coordinate with the Content where the content will be automatically rendered on the client device upon approaching the coordinate, allowing for specific Transforms, e.g. Translation (movement in the x, y and z axes), Rotation (rotation about the x, y, and z axes), and Scale (entity scaling), for precise placement; and (2) Content can be posted using Proximity Tracking, which is associating a particular coordinate with the Content, requiring the client device to be within a pre-determined proximity distance to the coordinate of the Content to enable the Content to be viewed or otherwise rendered. The requisite proximity distance could be set by the system or by the client device viewing the content or the client device posting the content. For example, someone could post a photo of their coffee and the text “I love lanes” to the “Coffee” Community in the Sacramento Region.

### Filter Sets

Filter sets represent a set of filters along with a title and optional description that can be shared directly to other client devices via a Uniform Resource Locator (URL), or other addressing methodology, or indirectly to all client devices who are physically inside of the Region to which the Filter Set belongs. Some inclusion filters include: Communities to include, users to include, and Posts to include. Some exclusion filters are Time (e.g., time since posting), Likes (Likes subtracted by Dislikes), types of Mature Content in the Post, quantity and/or type of Reports, Posts to exclude, users to exclude, and whether to exclude content by users who are not Verified Residents. The Filter Set's filters can be applied to various forms of content and have various effects; Posts, Comments, Community Chats, and shared Filter Sets can all be filtered. Content filtering can be enacted by hiding the content completely or by blurring the content and requiring the content to be selected to (e.g., tapped) to remove the blur effect. Filter Sets that are shared publicly to the Region can be “favorited” by client devices. A client device's “Favorited” Filter Sets can be easily viewed later for reuse. Additionally, publicly shared Filter Sets can be sorted by the number of times they have been “Favorited”, making it easy to see which shared Filter Sets are popular in a given Region. For example, a Filter Set could be titled “Easy Sunday” and include the Communities “Parks”, “Treats”, and “Coffee” and exclude anything posted longer than a week ago (Time) or has less than five likes (Likes) or has Mature content (Mature Content) or has more than two reports (Reports). Any posts that meet any of these exclusion criteria would be hidden or blurred. For another example, a Filter Set could be titled “Mystery Adventure” and be publicly shared to its Region. The Filter set could have no Communities included and only a number of specific Posts included and no exclusion filters applied. This would result in only displaying the specifically included Posts.

### Augmented Reality Experience Capture

Client devices can take a photo, video, 3D photo, or 3D video of one or more Posts from a Community and can post that photo or video to the Community for feed-like viewing. For example, a user could see a post rendered in augmented reality that they find humorous and could take a video of it and then upload the video to the Community to which the Post was posted, where everyone who has access to the Community can see the Captured Experience.

### Resident Verification

A Resident Verification represents that a client device has been verified to continually be physically present in a Region. The verification process consists of having the client device “check in” to a Region over the course of a specified number of days within a specified range of days, e.g., 15 days of physical presence verified over the course of 30 days. “Checking in” is accomplished by verifying that the client device's location is within the Region's geographical bounds. One use for this could be to grant Residents extra capabilities, e.g., being able to propose and vote on new Communities and changes to existing Communities, as well as continuous access to Communities in the Region of which they are a Resident even when the client device is not within the Region's geographical bounds. This enables users to understand whether other users are part of their community and Region or are Residents of a different Region. This helps users to have a better understanding of with whom they are interacting. For example, a client device could start the verification process to be a Resident of the Region “Sacramento.” Afterwards, they could have 30 days to use the app to “check in” within the geographical bounds of the Region “Sacramento” on 15 different days.

### Reports

Users, Communities, Posts, Comments, Community Chat Messages, and Filter Sets can all be reported. A Report includes a report reason and an optional description of why the Report is being filed. These can be used to help client devices filter content using Filter Sets. Reports can be made visible to client devices for Report Assessment, allowing client devices to either affirm or refute the veracity of a filed Report against a piece or item of content. This can lead to Reports being deleted or not considered, aiding the users in their ability to navigate and filter out content they do not care to see. One or more AI (Artificial Intelligence) Agents can also file Reports of their own, as well as filing public Report Assessments (affirmations or refutations of Reports). The AI Agent's filed Reports and Report Assessments can be affirmed or refuted by non-AI client devices. Client devices can also control the level of trust to put in an AI Agent. This means that a client device can choose the level to which they trust or distrust the AI Agent on a sliding scale, which in turn multiplies the AI Agent's Report and Report Assessment counts by the factor associated with the client device's AI Agent Trust Level. This means the client device can choose to completely disregard an AI Agent's approach to moderation or to fully embrace the AI Agent's approach to moderation. The client device can enable one or more AI Agents, each with their own AI Agent Trust Level.

For example, a client device could read a Comment on a Post and file a Report with the report reason “Contains Mature Content” and select “Language” as the Mature Content descriptor. Another client device could see that the Comment has been reported. They could then view the Report and choose to agree or disagree with the filed Report, adding or subtracting validity from the original Report. Additionally, an AI Agent could read the comment and determine whether it finds it likely that the Comment should be reported for any of the listed available Report reasons, filing a Report for any or all likely reportable offenses. The AI Agent could also read the previously filed Report on the Comment and decide whether the existing Report is likely true or not. It could then file a Report Assessment, choosing to agree or disagree with the filed Report.

The AI Agent Trust Level scale could be configured to interact with Filter Sets, so that if a client device had their active Filter Set configured to block all content with more than two Reports, and their AI Agent Trust Level set to trust the AI Agent by a factor of two, then if a Post had received only a singular Report by the AI Agent, the Post would be filtered. The Post's adjusted Report count would be two after multiplying the single AI Agent Report by the AI Agent Trust Level factor of 2 (1×2=2).

### Region Chat

Region Chat is a feed of Community Chat Messages that includes all of the Community Chat Messages that were posted to the Communities included in the client device's active Filter Set. This feed of chat messages is filtered by the client device's Filter Set and can blur or remove messages that violate any of the Filter Set's criteria. For example, if a client device had a Filter Set configured that contained all the Communities in the Region, but filtered content that had less than five likes, the feed would include all of the latest messages from the different Community's chat feeds, but would remove or blur all of the messages that had received less than five likes.

### Region AI Agents

A Region may have one or more associated Artificial Intelligence (AI) Agents that client devices can communicate with to quickly and colloquially ascertain information about the Region. These AI Agents may learn from the various existing content that belongs to the Region, e.g. Posts, Comments, Chats, etc., to provided informative and helpful answers to questions, in addition to any knowledge that the AI Agents may have been previously trained on. The AI Agents may specifically cite and reference existing content as a source of truth for their responses. These AI Agents may answer questions about activities or places in the Region or create Filter Sets to aid the client device in navigating to activities/places that interest them. For example, a client device may ask “What's going on this Saturday morning?”, and the AI Agent may respond with a list of activities that have been discussed as coming up or recurring events, sourced from and citing existing Posts, Comments, Chats, etc. Additionally, the AI Agent may offer a Filter Set based on the suggestion, providing a set of Communities and/or Posts to include when navigating to these activities.

### Community AI Agents

A Community may have one or more associated Artificial Intelligence (AI) Agents that can client devices may communicate with to quickly and colloquially ascertain information about the Community or about the Region that the Community belongs to. These AI Agents may learn from the various existing content that belongs to the Community, e.g. Posts, Comments, Chats, etc., to provided informative and helpful answers to questions, in addition to any knowledge that the AI Agents may have been previously trained on. The AI Agents may specifically cite and reference existing content as a source of truth for their responses. For example, a client device may ask an AI Agent in the “Coffee” Community, “Where should I go to get the best espresso in town?”, and the AI Agent may respond with further questions about what style of espresso is preferred or may respond with some highly recommended cafe's by the users in the Community, citing Comments, Posts, and/or Chats as reference. This natural expression allows users to quickly see alternatives and learn intimately about a Region from individuals' own opinions.

### Community VR Worlds

A Community may have one or more associated virtual worlds, which client devices can access using certain technologies (e.g., a virtual reality headset). Some aspects of these virtual worlds that are customizable by the Community's client devices include world appearance, client device appearance, physics, and allowed conduct. For example, the Community “Coffee” could have a virtual world associated with it set up to make it easy for clients to show different brewing techniques to each other in person (virtually). This world could be styled to look like a coffee shop and have a number of different brewing devices on a table. This world could be configured to only allow client appearances that represent humans. For another example, the Community “DnD” could have a virtual world styled to look like a mystical forest for client devices to gather and play DnD together in person (virtually).

### Community Vendors

A Community may host a digital marketplace for one or more individuals or organizations to sell and/or advertise their goods or services through as a Vendor. This provides an immediate and location-relevant purchase experience for users as well as providing a simplified and streamlined process for Vendors to advertise goods/services to potential customers who are in physical proximity to where the goods/services are being sold. Advertisements for these Vendors' goods/services may be displayed to users who are participating in the Community, e.g. users who are using the Community's Chat function, using a Filter Set containing the Community, etc., or the advertisements may be displayed when a client device is within a predetermined proximity to a predetermined location in the Region, e.g. present an ad for a local coffee shop if the user is within one thousand feet of the coffee shop. This form of advertisement and marketing bypasses the need for collecting data on individuals to provide targeted marketing, i.e. marketing that is relevant to the end user's preferences and inclinations. Rather, this process enables marketing toward a group of people with a shared interest or who are physically in proximity to a Vendor, instead of marketing to and tracking each individual user. This provides a layer of data obfuscation for the user, enhancing user privacy and simplifying the process of targeted marketing. For example, there could be a Community for a local stadium. An individual or organization, e.g. the stadium and/or its various concessionaires, could be a Vendor in the Community and offer to sell food or beverages to client devices through the Community in the app, or could offer goods sold at the stadium, or offer goods/services contextual to a currently occurring event. If a basketball game was currently underway, a client device could purchase a basketball jersey from their seat and pick it up on their way out, have it brought to their seat, or delivered to an address, forgoing a wait in a line to purchase something. If a musical artist was performing, the Community could offer vinyl records, CDs, cassettes, posters, apparel, or other merch for client devices to purchase from their seats, again forgoing a long wait in line to purchase something.

### Community Live Audio Stream

A Community may provide access to broadcasts or enable users to listen to one or more live audio streams, akin to a traditional radio station, but constrained to be hosted and accessed by those who have access to the Community. This would enable client devices to share auditory content immediately with a range of clients who are in their general physical proximity. For example, an individual attending a political event could use their client device to host a live audio stream in the Community “Politics” to make available the audio of the political event to all client devices in the Community's Region. For another example, an individual could use their client device to host a live audio stream in the Community “Music” of them composing or performing music in real time.

### Community Live Video Stream

A Community may provide access to broadcasts or enable users to watch one or more live video streams, with hosting and viewing access constrained to those who have access to the Community. This video may be broadcast, and likewise consumed, as 3D video and/or traditional 2D video. This would enable client devices to share multimodal video content immediately with a range of clients who are in their general physical proximity. For example, the organizers of a musical performance could use a client device to host a live video stream in the Community “Music” of the musical performance as it is happening, making it available to all the client devices in the Community's Region.

### Use Cases

In general, the application of an example embodiment can push users outside to see what others have posted, increasing foot traffic in cities thereby increasing local commerce and increasing community engagement. Local, geographically-placed content eliminates bots completely, and requires trolls or bad actors to travel to a Post to interact with it, or to travel to Region to participate in a live-chat.

Region-based live-chats provide valuable communication with people who live in close vicinity to each other. It can be used to quickly find suggestions for activities, places to eat or drink, general chatting, organizing events, or more.

A Community could be made for an event like a concert or festival, where the organizers can post useful markers around for event-goers to find key features of the event, such as different stages, bathrooms, the medical tent, etc. A Community could be made called “Coffee” where users could post their thoughts outside the different cafes so others can see what their coffee and food looks and tastes like from the street as they walk by. They could also use the live-chat feature of the Community to ask people in real-time where they would suggest they should go. A Community could be made and called “Tourism” by the city where city officials can post at landmarks and sightworthy locations, only allowing city officials to post to maintain integrity.

This would be valuable to increase the incentive to travel to a different city to see what unique Regions, Communities, and Posts are there. This can help travelers find the things they are interested in when traveling, increasing tourism.

### Implementation of Example Embodiments

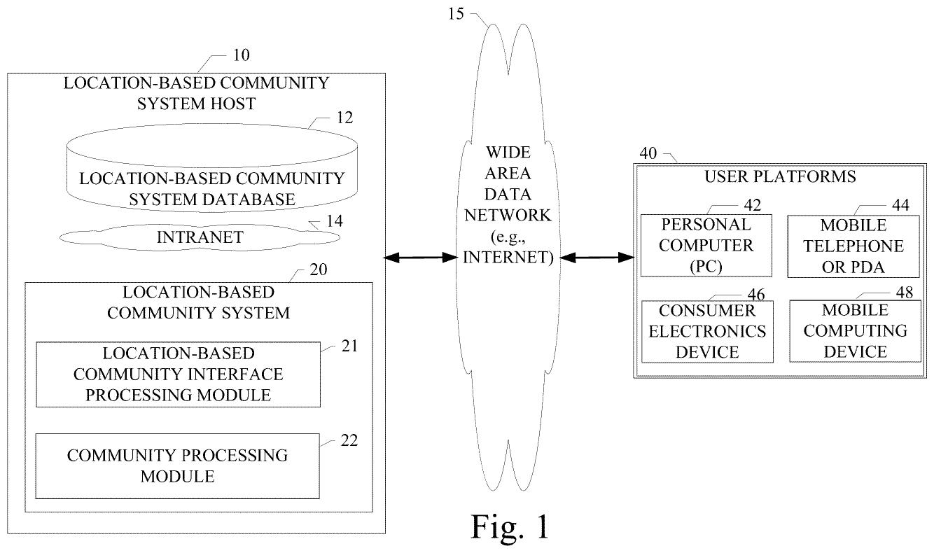

Referring now to FIG. 1, an example embodiment of a location-based community system 20 and a network ecosystem in which the location-based community system 20 can operate is illustrated. The location-based community system 20 provides a computer-implemented tool or software application (app) as part of a location-based engagement platform to automate and realize a metaverse social media platform that leverages Augmented Reality (AR) and Geolocation to allow users to create Posts of 3D Content at geographical coordinates and submit the posts to a Community focused around a shared interest. In various example embodiments, an application or service, typically provided by or operating on a host site (e.g., a website) 10, is provided to simplify and facilitate the downloading or hosted use of the location-based community system 20 of an example embodiment. In a particular embodiment, the location-based community system 20 can be downloaded from the host site 10 by a user at a user platform 40. The downloaded location-based community system 20 can be used as an application or app executing on the user platform 40. Alternatively, the location-based community system 20 can be hosted by the host site 10 for a networked user at a user platform 40. The details of the location-based community system 20 for an example embodiment are provided below.

Referring again to FIG. 1, the location-based community system 20 can be in network communication with a plurality of user platforms 40. The host site 10 and user platforms 40 may communicate and transfer data and information in the data network ecosystem shown in FIG. 1 via a wide area data network (e.g., the Internet) 15. Various components of the host site 10 can also communicate internally via a conventional intranet or local area network (LAN) 14.

Networks 15 and 14 are configured to couple one computing device with another computing device. Networks 15 and 14 may be enabled to employ any form of computer readable media for communicating information from one electronic device to another. Network 15 can include the Internet in addition to LAN 14, wide area networks (WANs), direct connections, such as through a universal serial bus (USB) port, other forms of computer-readable media, or any combination thereof. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those of ordinary skill in the art. Furthermore, remote computers and other related electronic devices can be remotely connected to either LANs or WANs via a wireless link, WiFi, Bluetooth™, satellite, or modem and temporary telephone link.

Networks 15 and 14 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 15 and 14 may also include an autonomous system of terminals, gateways, routers, and the like connected by wireless radio links or wireless transceivers. These connectors may be configured to move freely and randomly and organize themselves arbitrarily, such that the topology of networks 15 and 14 may change rapidly and arbitrarily.

Networks 15 and 14 may further employ a plurality of access technologies including 2nd (2G), 2.5, 3rd (3G), 4th (4G), 5th (5G) generation radio access for cellular systems, WLAN, Wireless Router (WR) mesh, and the like. Access technologies such as 2G, 3G, 4G, 5G, and future access networks may enable wide area coverage for mobile devices, such as one or more of client devices 141, with various degrees of mobility. For example, networks 15 and 14 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 15 and 14 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 15 and 14 may include virtually any wired and/or wireless communication mechanisms by which information may travel between one computing device and another computing device, network, and the like. In one embodiment, network 14 may represent a LAN that is configured behind a firewall (not shown), within a business data center, for example.

The user platforms 40 may include any of a variety of providers and consumers of network transportable digital data. The network transportable digital data can be transported in any of a family of file formats and associated mechanisms usable to enable a host site 10 and a user platform 40 to send and receive digital data over the network 15. In an example embodiment, the transferred digital data can be in a particular file format, such as a standard text format, a text messaging format, an email format, a voice file format, or a CSV (Comma Separated Values) format; however, the various embodiments are not so limited, and other file formats and transport protocols may be used. For example, data formats other than text, chat, voice, or CSV or formats other than open/standard formats can be supported by various embodiments. Any electronic file format, such as conventional database formats, Portable Document Format (PDF), audio (e.g., Motion Picture Experts Group Audio Layer 3—MP3, and the like), video (e.g., MP4, and the like), and any proprietary interchange format defined by specific sites can be supported by the various embodiments described herein.

In a particular embodiment, a user platform 40 with one or more client devices enables a user to access data provided by the location-based community system 20 via the host 10 and network 15. Client devices of user platform 40 may include virtually any computing device that is configured to send and receive information over a network, such as network 15. Such client devices may include portable devices 44, such as cellular telephones, smart phones, camera phones, display pagers, radio frequency (RF) devices, infrared (IR) devices, global positioning devices (GPS), Personal Digital Assistants (PDAs), handheld computers, wearable computers, tablet computers, AR devices, integrated devices combining one or more of the preceding devices, and the like. The client devices may also include other computing devices, such as personal computers 42, multiprocessor systems, microprocessor-based or programmable consumer electronics, network PCs, and the like. The client devices may also include other processing devices, such as consumer electronic (CE) devices 46 and/or mobile computing devices 48, which are known to those of ordinary skill in the art. As such, the client devices of user platform 40 may range widely in terms of capabilities and features. Moreover, a web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript™, EXtensible HTML (xHTML), Compact HTML (CHTML), and the like, to display and/or send digital information. In other embodiments, mobile devices can be configured with applications (apps) with which the functionality described herein can be implemented.

The client devices of user platform 40 may also include at least one client application that is configured to send or receive posts, content, region information, community information, filter information, and/or control data from another computing device via a wired or wireless network transmission. The client application may include a capability to provide and receive text data, graphical data, image data, video data, audio data, and the like. Moreover, client devices of user platform 40 may be further configured to communicate and/or receive a message or chat, such as through a Short Message Service (SMS), direct messaging (e.g., X™ or Twitter™), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

Referring again to FIG. 1, the location-based community system 20 for an example embodiment is shown to include a location-based community system database 12. The database 12 can be used to retain a variety of information data sets including, but not limited to, region information, community information, post information, filter set information, report information, user information, location information, and the like. It will be apparent to those of ordinary skill in the art that the location-based community system database 12 can be locally resident at the host site 10 or remotely located at other server locations or stored in network cloud storage.

Referring again to FIG. 1, host site 10 of an example embodiment is shown to include the location-based community system 20. In an example embodiment, location-based community system 20 can be an executable module of data processing instructions configured to be executed by a data processor of the location-based community system host 10 or user platform 40. The location-based community system 20 can include a location-based community interface processing module 21 and a community processing module 22. The location-based community interface processing module 21 can be configured to control and manage the user interface interactions of client platforms 40 with the location-based community system 20. The location-based community interface processing module 21 can facilitate data communication and the transfer of data, content, posts, and/or documents to/from a user at a user platform 40. The community processing module 22 can be configured to manage data associated with the location-based community, post content, regions, communities, filters, AR processing, reports, chat, and user information as described in more detail below. The location-based community interface processing module 21 and the community processing module 22 can be configured to perform the processing as also described in more detail below. Each of these modules (21 and 22) can be implemented as software components executing within an executable environment of location-based community system 20 operating on host site 10 or user platform 40. The location-based community interface processing module 21 and the community processing module 22 can be resident at the host site 10 and/or fully or partially resident on a user platform 40. The components and processes to create and use the location-based augmented reality community platform as embodied in the location-based community interface processing module 21 and the community processing module 22 are described in more detail below.

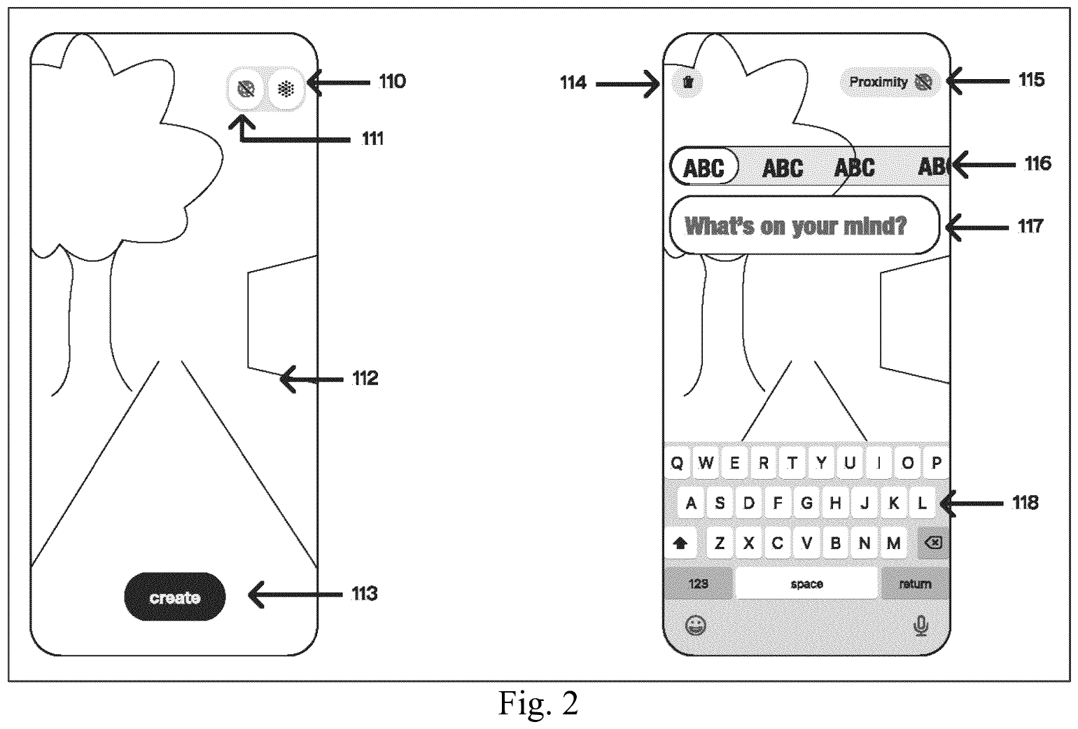

FIGS. 2 through 16 illustrate example screenshots of a mobile device user interface of an example embodiment. This user interface and the related screenshots can be presented and managed by the location-based community interface processing module 21 and the community processing module 22. In particular, FIGS. 2 through 6 illustrate methods for enabling a content creation process in an example embodiment. Referring to FIGS. 2 through 6, the Look Mode Button 110 shown in FIG. 2 indicates to the client device what Look Mode is active. Selecting (e.g., tapping) the Look Mode Button 110 toggles between Look, Create, and Capture modes. In the example shown, the client device is currently in Create mode. The AR Viewing Configuration Mode Button 111 toggles between Geo-Tracking and Proximity-Tracking (the current selection). A live camera feed 112 is displayed on screen. The Create button 113 is selected (e.g., tapped) to begin the content creation process. The Delete Creation Button 114 can be used to discard the created content. The Expanded AR Viewing Configuration Mode Button 115 toggles between Geo-Tracking and Proximity-Tracking (the current selection). The Font Picker Bar 116 presents a number of fonts to be selected to style the created content. The content 117 being created is previewed in 2D on the screen. The client device may input text 118 to create content.

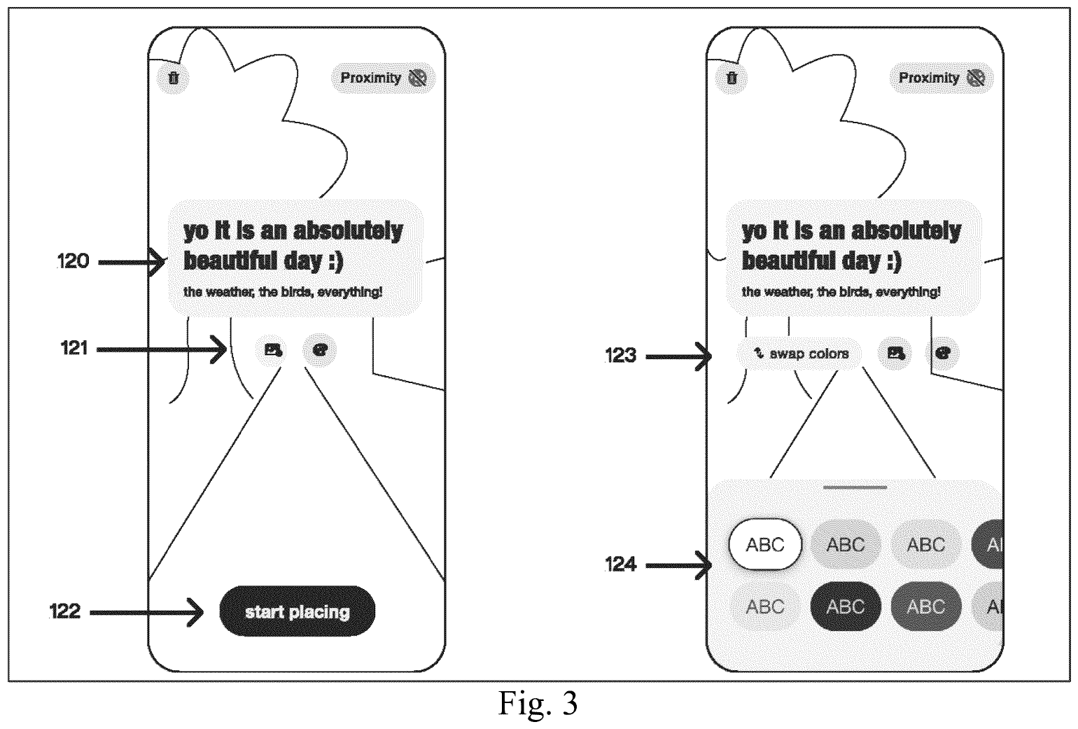

Referring to FIG. 3, the client device has input title text and body text and the 2D preview of the created content 120 is being displayed on the screen. Content Styling Buttons 121 are provided. From left to right, there is a Media Picker Button and a Color Picker Button. The Media Picker Button enables the client device to add media (e.g., photo, video, etc.) to their post. The Color Picker Button allows the client device to style the content with different colors. The Begin Content Placement Button 122 renders the content in 3D in augmented reality. The added button 123 with the text “swap colors” allows the client to swap the background color with the text color. The Color Picker 124 provides controls as a series of buttons enabling the client to select different color sets from which to choose.

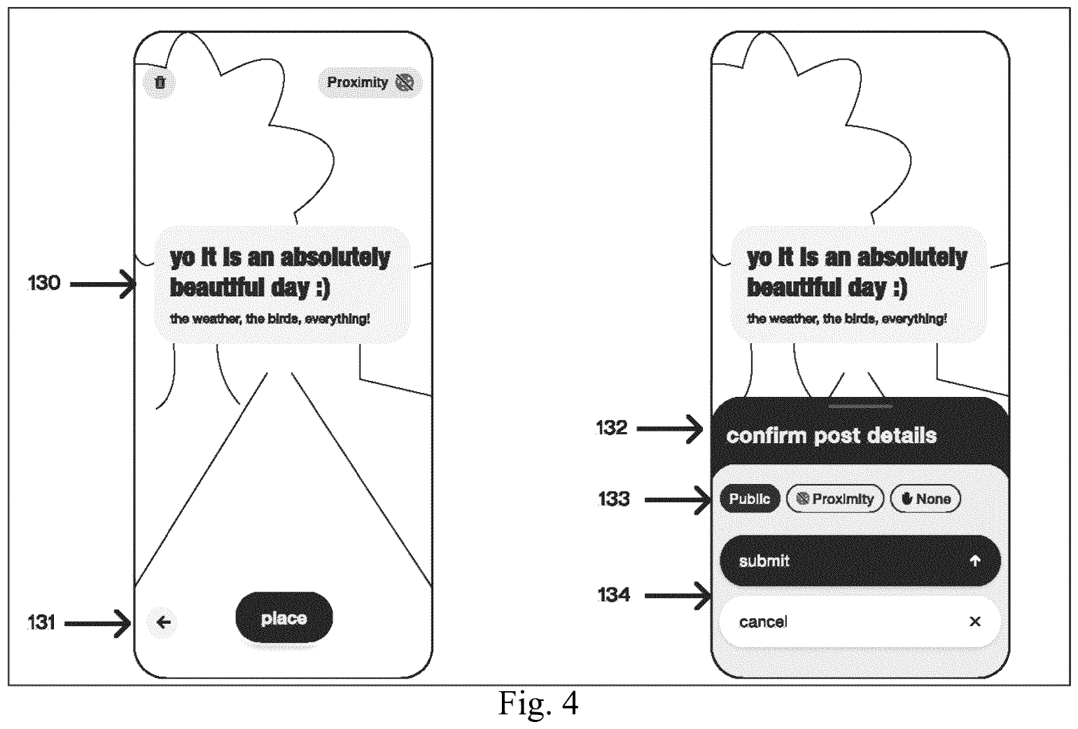

Referring to FIG. 4 in the example shown, Content 130 is now rendered in AR, anchored in front of the client device. If the client device user is satisfied with the content and placement, the user may press the button “place” 131 to place the content at that geographical location. If the client device user would like to change something about the content, they can press the leading left arrow button. Confirmation Controls 132 are provided after the “place” button was pressed and the confirmation controls 132 are presented. The content is now anchored to whatever geographical coordinates the client device was located at when the “place” button was pressed. The Post Details 133 provide three tags displayed in order from left to right: (1) the Community to which the Post is being posted—“Public” in this case, (2) the AR Viewing Configuration to use—“Proximity” in this case, and (3) the Mature Content contained in the Post—“None” in this case. If (1) is selected, a list of available Communities will be presented to select one from. If (2) is selected, the client device will attempt to initiate Geo-Tracking; if the client device is capable of Geo-Tracking, the location at which the client device is located supports Geo-Tracking, and Geo-Tracking localization is successful, then Geo-Tracking mode will be active. If (3) is selected, the client device will display a list of possible Mature Content the client can indicate that is included in the Post. If the client device user is satisfied with all of these entries and the Post content and placement, they may submit their Post using the “submit” button 134. If they are dissatisfied, they may press the “cancel” button.

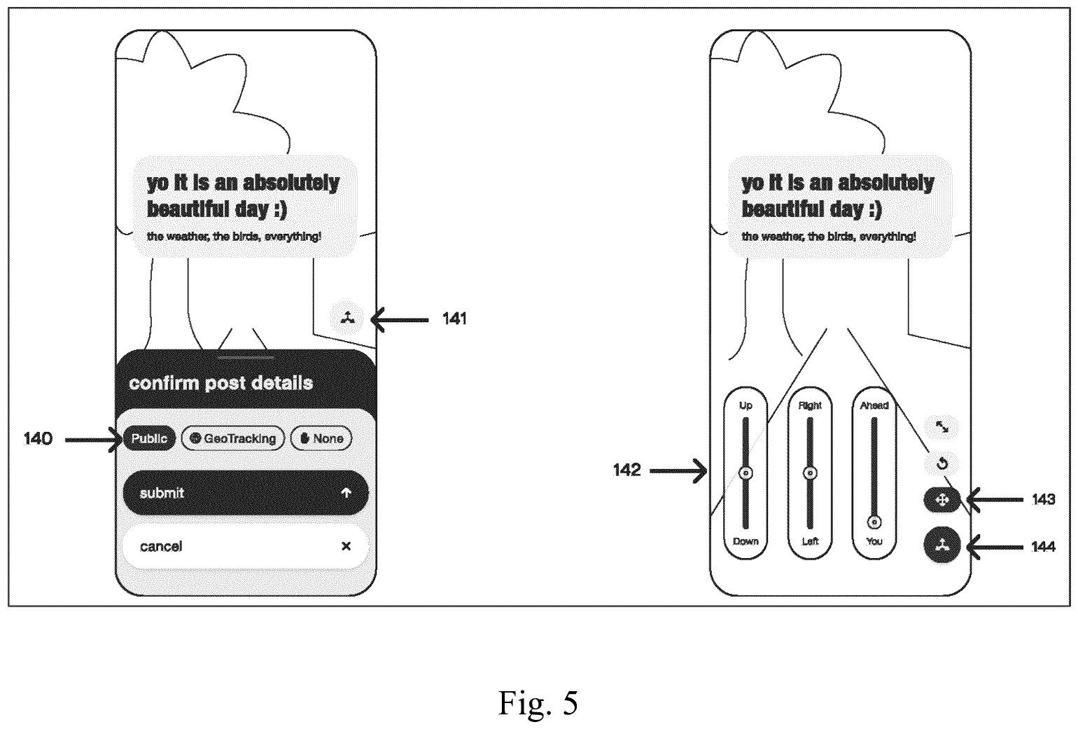

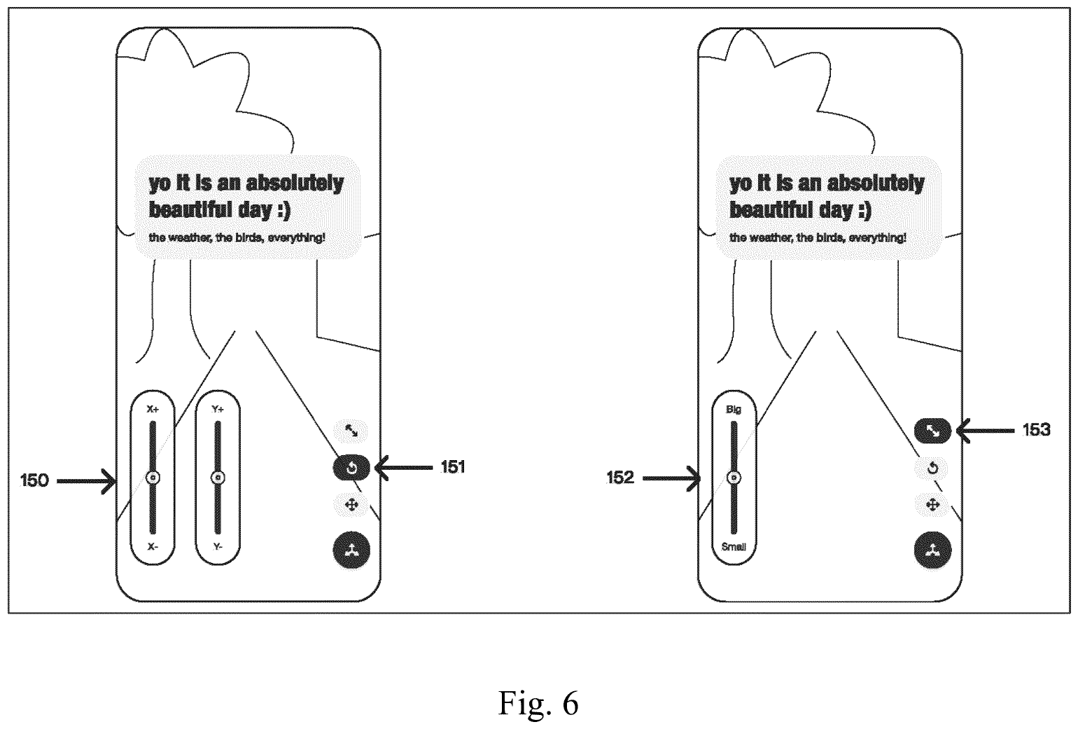

Referring to FIGS. 5 and 6, the client has selected the AR Viewing Configuration button and successfully initiated Geo-Tracking, and the AR Viewing Configuration Tag 140 has been updated to indicate this. The Content Placement Button 141 is presented for fine-tuning the content's Transform (Translation, Rotation, and Scale), now that the client device is using Geo-Tracking. In the example shown, the client device has selected the Content Placement Button and the Transform controls 142 are presented. The three sliders can be used to adjust the Translation of the Content. The Translation Button 143 is selected so Translation controls are displayed. The Content Placement Button 144 can be used to open a panel of buttons that may be used to adjust the Transform of the Content (Translation, Rotation, and Scale). This button is currently toggled open. Selecting the button again would present the Confirmation Controls once again and hide the Transform Controls. The two sliders 150 can be used to adjust the Rotation of the Content. This type of content disallows Yaw rotations, so only two sliders are displayed. In the example shown, the Rotation button 151 is selected so Rotation controls are displayed. The slider 152 can be used to adjust the Scale of the Content. In the example shown, the Scale button 153 is selected so Scale controls are displayed.

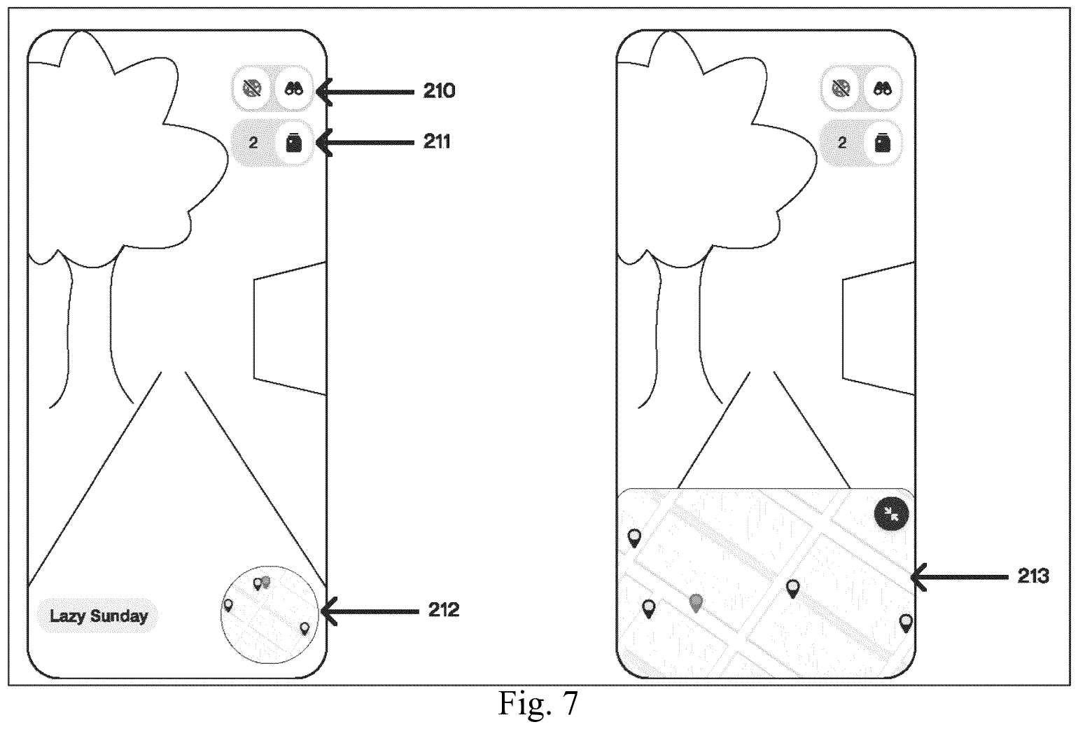

FIGS. 7 through 9 illustrate methods for enabling a Post interaction process in an example embodiment. Referring to FIGS. 7 through 9, the Look Mode Button 210 is shown. This button indicates to the client device what Look Mode is active. Selecting (e.g., tapping) the Look Mode Button 210 toggles between Look, Create, and Capture modes. The client device is currently in Look mode. To the left, the AR Viewing Configuration Button indicates the active configuration is Proximity-Tracking. Nearby Posts Counter and Nearby Posts Button 211 displays the count of the nearby renderable posts on the left, and a button for displaying the list of nearby posts on the right. The active Filter Set title 212 can also be displayed (e.g., “Lazy Sunday”). This title 212 can be selected (e.g., tapped) to view the Filter Set's details. A Post minimap can also be displayed to show where Posts are located relative to the client device. Selecting the Post minimap expands the map. The expanded Post map 213 enables easier viewing of Posts located relative to the client device. The map 213 includes a toggle at the top, trailing edge to collapse the map back into the minimap.

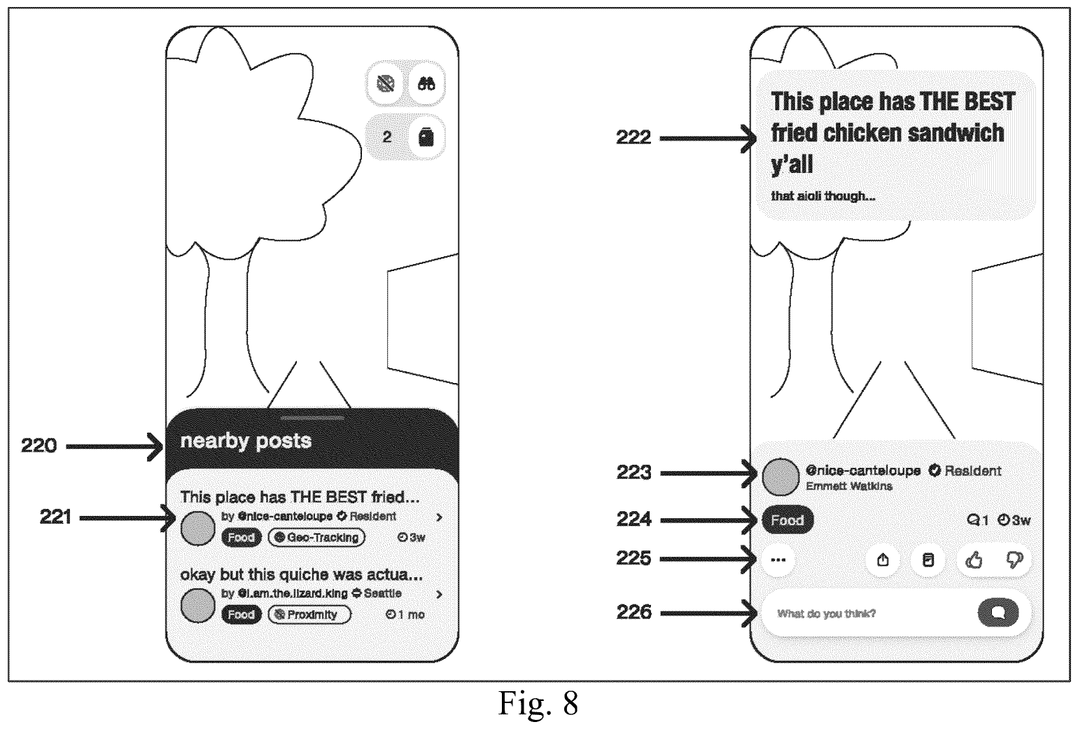

Referring to FIG. 8 in the example shown, the Nearby Posts Button 220 was pressed and, as a result, the list of nearby Posts is presented. The list of nearby Posts 221 is shown in the example. The format of an item in the list is as follows: the first line is the text of the Post (if any) truncated to the length of one line. The second line has the user's profile photo on the left, followed by two lines of text. The first line details the user's username and their Resident Verification status. The second line details the Community to which the Post was posted, followed by the AR Viewing Configuration of the Post, followed by the amount of time since the Post was posted. In the example shown, the first entry 222 of the Nearby Posts list was selected, which has presented the Post on the client device in AR. Once the client device selects a Post to present, the Post Interaction Controls 223 are presented on the client device. The first line of information details the user's profile picture, username, Resident Verification status, and name. The line 224 details on the leading edge the Community to which the Post was posted and details on the trailing edge the number of Comments the Post has received and how much time has passed since the Post was posted. The line 225 provides controls for reporting the Post, sharing the Post, viewing the Post in a 2D Reader view (if possible), and liking or disliking the Post. The Comment Bar 226 allows the client device to leave a Comment on the Post.

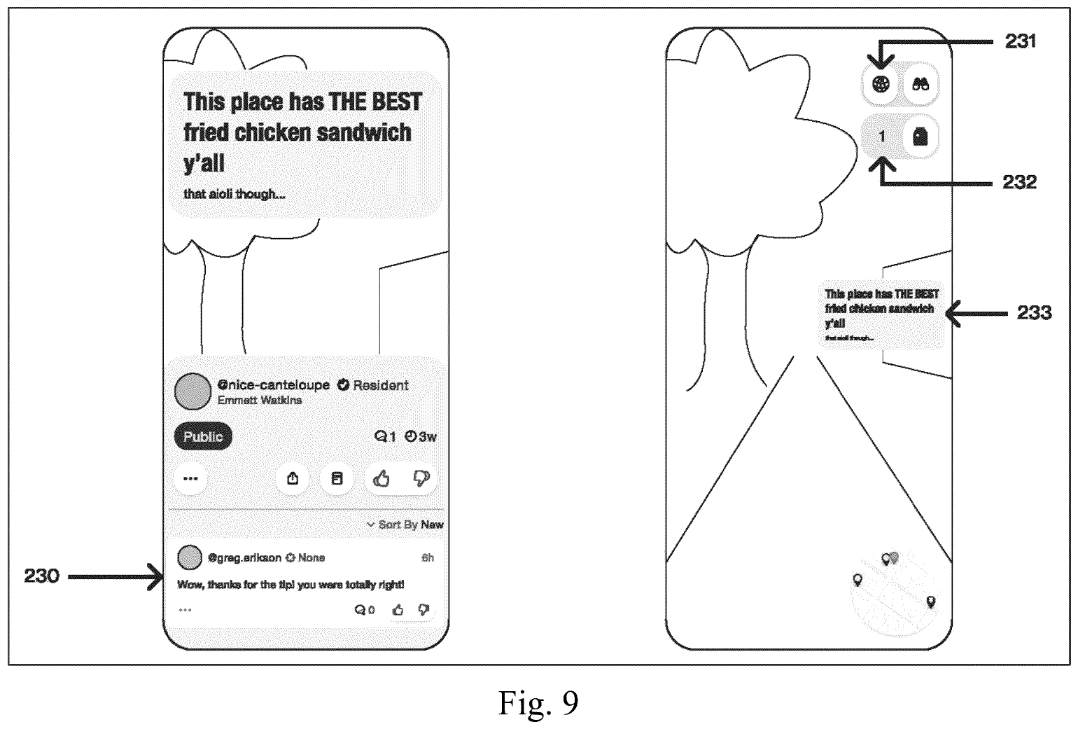

Referring to FIG. 9 in the example shown, the client device user has caused presentation of the Comment List 230 by either swiping up or by selecting the Comment Count indicator. The Comment List has a Sort Button on the top trailing edge, and then displays all the Comments below that. The Comment in the example shown details the commenter's profile photo, username, and Resident Status followed by the time since the Comment was submitted on the first line. After that line is the text of the Comment. Followed by that is an ellipsis control for reporting or sharing the Comment, followed by the Comment reply indicator and like/dislike buttons. The AR Viewing Configuration 231 is set to Geo-Tracking in this example. This causes Geo-Tracking enabled content to automatically render as the client device approaches the geographical location associated with the content. Note that the Nearby Post Counter 232 has decremented to one; because, one of the two nearby Posts was submitted with Geo-Tracking configuration, so the Post has already been rendered. The Post 233 rendered using Geo-Tracking has rendered at a distance from the client device at a specific location, rather than being presented manually by the client device.

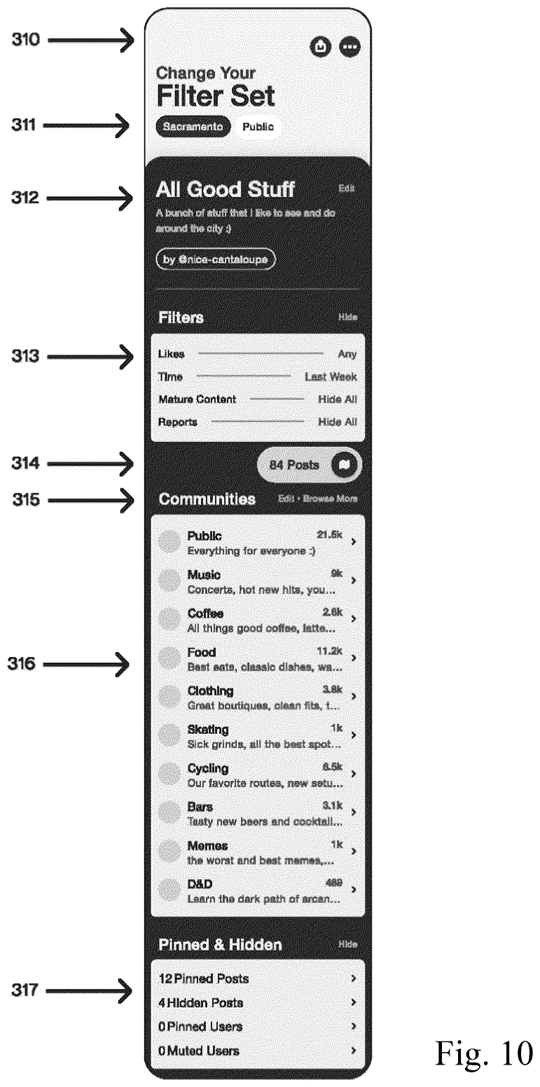

FIGS. 10 through 13 illustrate methods for enabling a Filter set creation process in an example embodiment. Referring to FIGS. 10 through 13, page 310 is used to view, edit, or create a Filter Set. If the client device is the creator of the Filter Set, the trailing buttons can be used to allow the client device user to delete the Filter Set or share the Filter Set with an individual or with the Region to which the Filter Set belongs. If the client device user is not the creator, the buttons allow the client device user to report or duplicate the Filter Set. Tags 311 can be used to display first the Region to which the Filter Set belongs (e.g., “Sacramento”), and then the Filter Set's shared status with the Region (e.g., “Public”), meaning the Filter Set is available to all client devices in the Region to view and use. Page 310 can also display the title (e.g., “All Good Stuff”) 312 and the description of the Filter Set, as well as the user who created the Filter Set (e.g., “nice-cantaloupe”). Section 313 details some of the different exclusion filters in the Filter Set. In order vertically, section 313 provides the Likes Filter, the Time Filter, the Mature Content Filter, and the Reports Filter. Each Filter can be tapped to display a set of available filter parameters from which to choose. On a trailing edge of page 310, a Post Counter 314 is provided, which displays the number of Posts in the Region that meet the Filter Set's criteria. Next to the Post Counter 314 is a Post Map button, which when selected displays a map of the available Posts around the client device at the client device's geographical location. Page 310 can display a list of the Communities 315 that are to be included in the Filter Set. Pressing “Edit” on the right allows the client device to remove Communities from the Filter Set. Pressing “Browse More” presents the Region Community Page, which is a list of all the public Communities in the present Region for the client device to add to the Filter Set. Each of the Community List Items 316 displays the title and number of members in the first row of text, with a description in the second row. The circle on the left is for the Community's thumbnail photo. Pressing on any of these List Items presents the Community Detail Page. Section 317 displays the pinned and hidden Posts and Users, which will always be displayed or hidden respectively, superseding the exclusion Filters above.

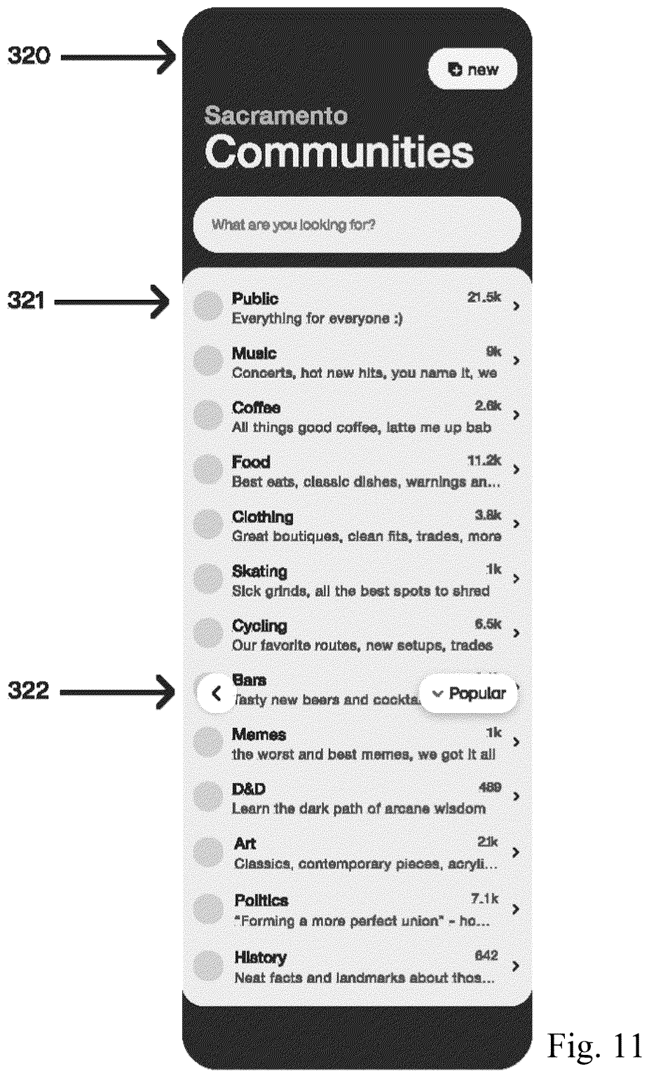

Referring to FIG. 11, the Region Community Page 320 is displayed. The Region Community Page 320 provides a listing of all the public Communities in the Region. The name of the Region is displayed at the top. The Region Community Page 320 provides a Community List 321. Selecting one of these Community List Items presents the Community Detail Page. The controls 322 allow the client device to return to the previous page or to sort the Communities.

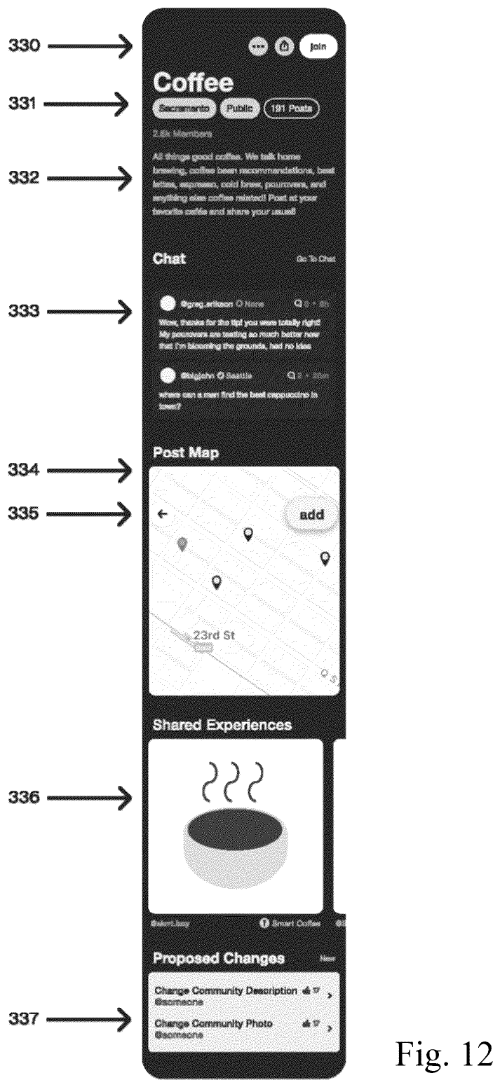

Referring to FIG. 12, the Community Detail Page 330 provides access to various Community features and details. On the top at the trailing edge, controls are provided to report, share, or join the Community. Section 331 details the title of the Community, the Region to which the Community belongs, whether the Community is public or private, and how many Posts have been submitted to the Community. A description of the Community 332 is also provided, with the count of the Community members above it. A Chat section 333 is provided for the Community, providing access to the Community Chat as well as previews of the two latest messages. A Post Map 334 is also provided to detail where Posts submitted to the Community can be found on a map. The leading button 335 allows the client device to return to the previous page, and the trailing button adds the Community to the Filter Set. Feed 336 displays the Shared Experiences that have been posted to the Community, along with the submitter username and an associated location below it. A Proposed Changes section 337 is also provided, which allows client devices to review and vote on proposed changes to the Community, as well as propose new changes if they are a Resident of the Community's Region, and a member of the Community.

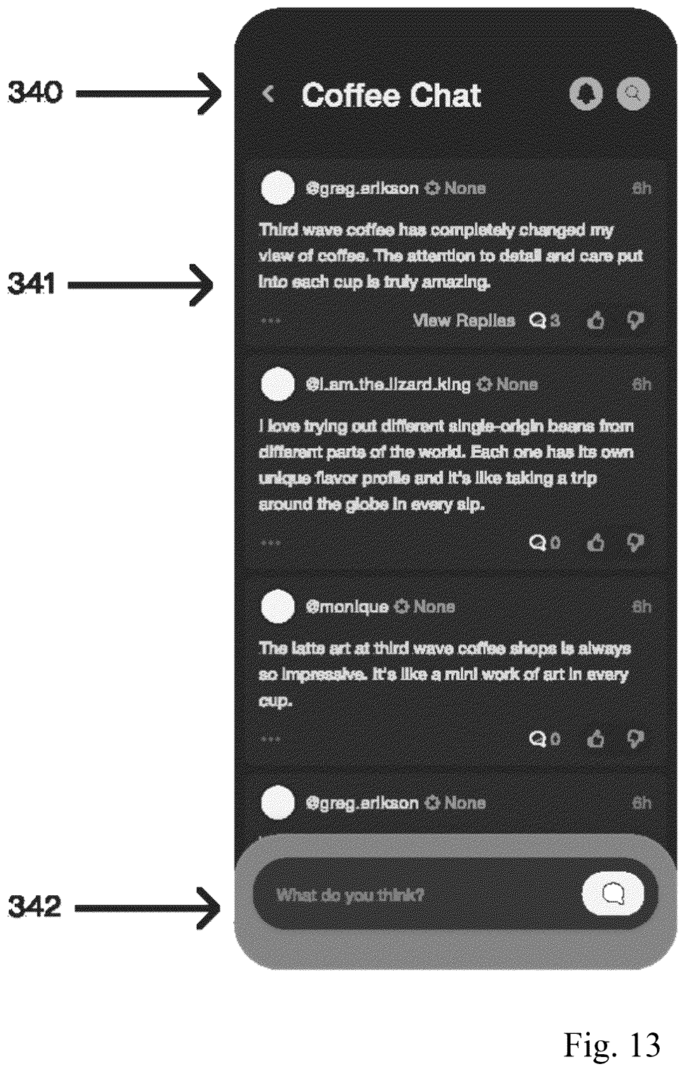

Referring to FIG. 13, the Community Chat Page 340 of an example embodiment is illustrated. On the leading edge, a button is presented to return to the Community Detail page and the title of the page is shown. On the trailing edge, buttons are provided to configure chat notifications and to search the chat. A number of chat messages 341 are shown that were posted to the Community Chat. This list is scrollable vertically to display more messages. The layout of the message is very similar to that of a Post Comment. A comment bar 342 is also provided where a client device can begin to compose a new chat message.

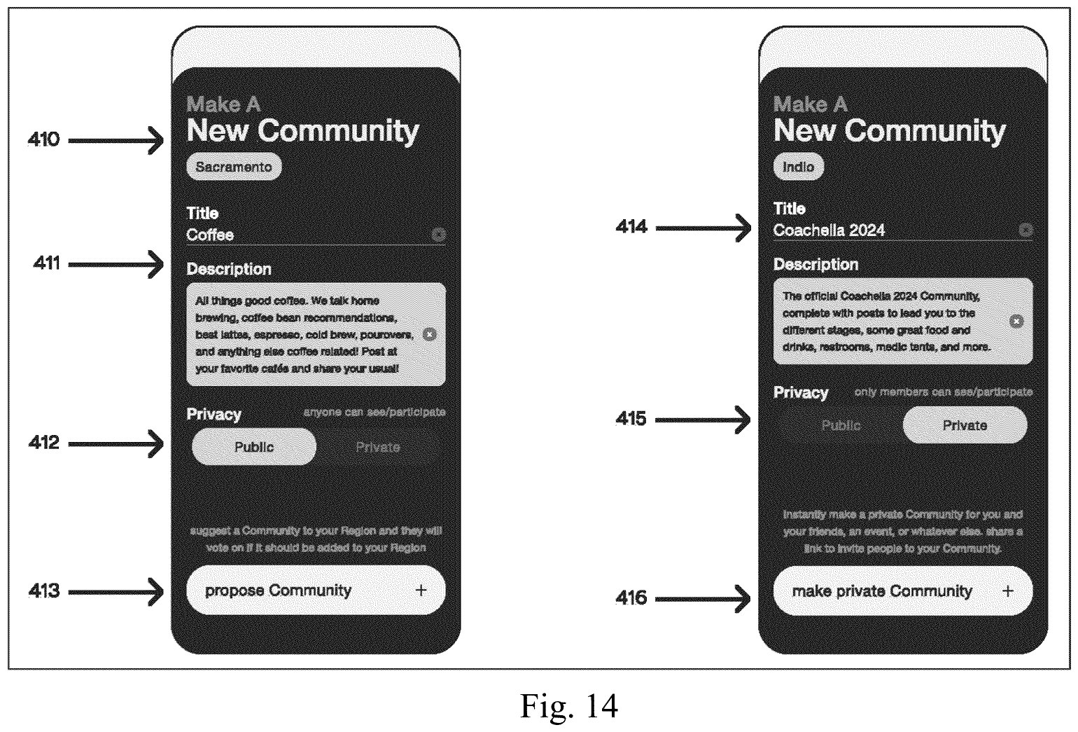

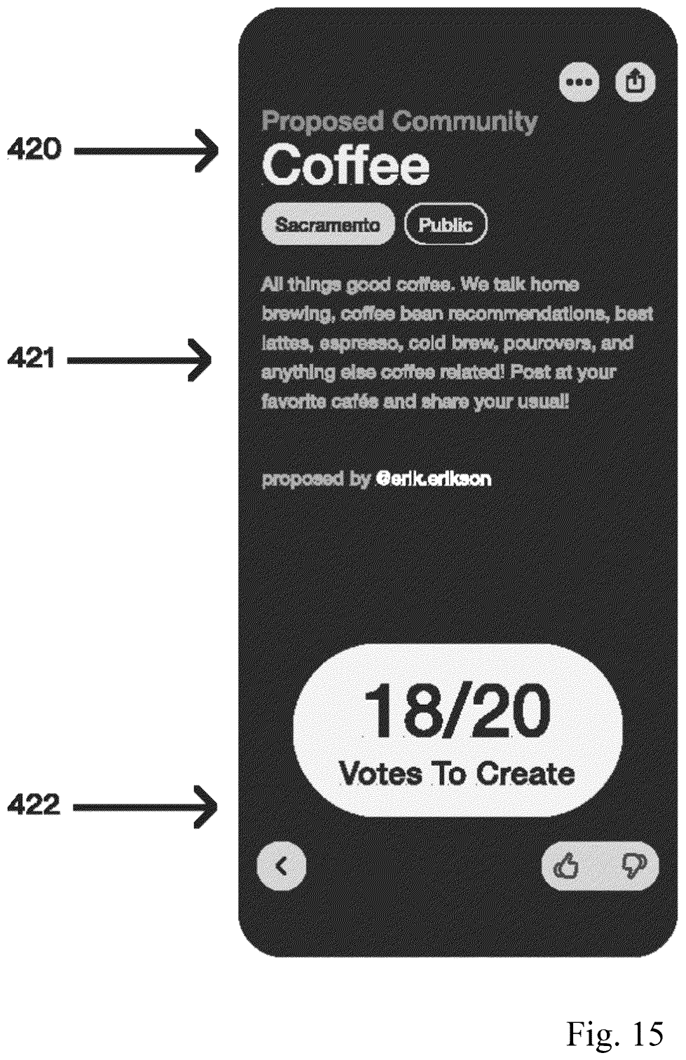

FIGS. 14 through 15 illustrate methods for enabling a Community creation process in an example embodiment. Referring to FIGS. 14 through 15, a Make A New Community Page 410 is shown. The Make A New Community Page 410 details at the top the Region for which the new Community is being made, “Sacramento” in this example. Fields 411 enable the client device to input a title and description. Toggle 412 enables the client device to select the Community's privacy setting, Public or Private. A button 413 is provided that when selected creates a new Proposed Community for the Region. The text above the button describes the action. Page 414 displays a private Community being created for an event. Note the Privacy toggle 415 is set to Private, and the text above the toggle indicates that, “only members can see/participate.” A button 416 and the text above it has updated to indicate the different action being taken—the immediate construction of a private Community.

Referring to FIG. 15, the Proposed Community Detail Page 420 is illustrated. The Proposed Community Detail Page 420 presents the details and voting controls for a Proposed Community. The title, the Region, and Privacy status are all displayed at the top. At the top trailing edge, buttons are provided for enabling the client device to report or share the Proposed Community. A description of the Community 421 is provided, with the user who proposed the Community detailed below the description. A vote counter 422 and voting controls are provided to allow the client device to vote for or against the creation of the Community.

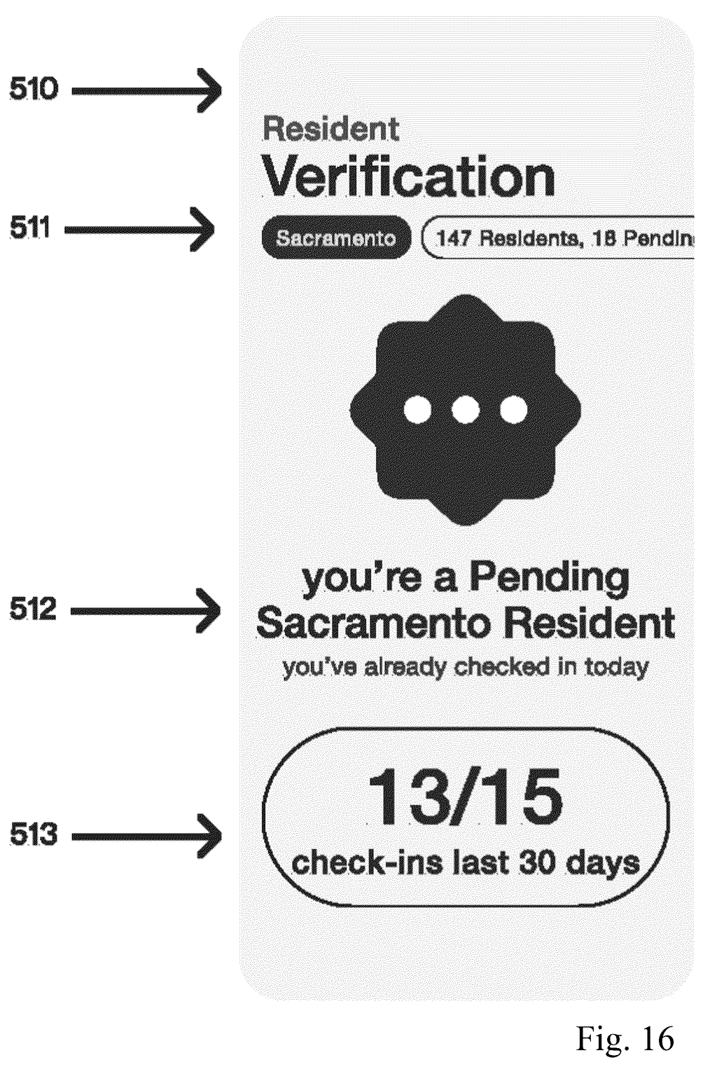

FIG. 16 illustrates methods for enabling a Resident Verification process in an example embodiment. Referring to FIG. 16, a Resident Verification Status Page 510 is shown. The Resident Verification Status Page 510 displays the client device's current Resident Verification status. Item 511 lists the Region in which the client device is currently located, as well as the number of other client devices, which have finished Resident Verification and which are currently underway in the current Region. Item 512 displays the client device's current Resident Verification status, along with an accompanying icon, and a notice of whether the client device has checked-in today. Counter 513 is provided to display the quantity of check-ins the client device has logged in over the last 30 days.

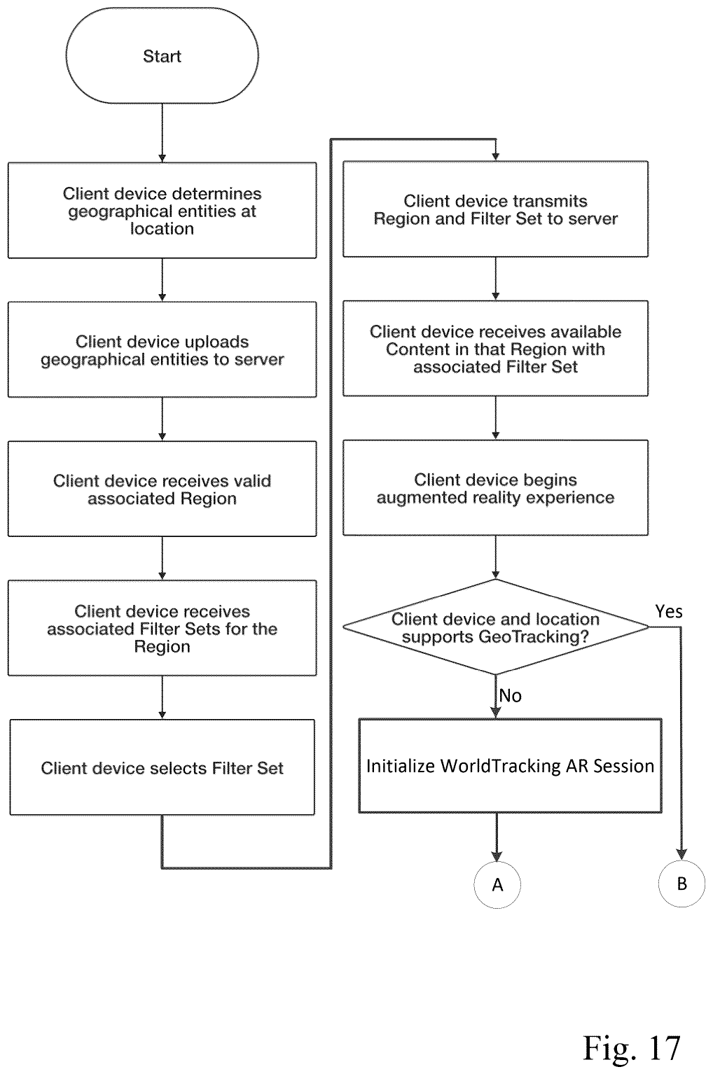

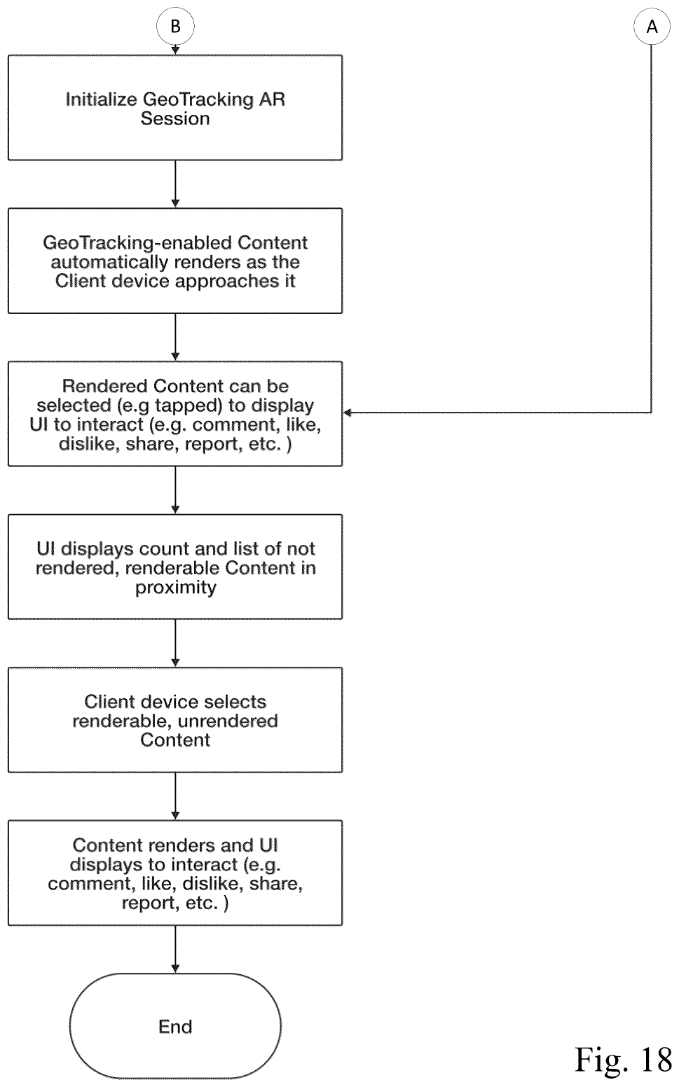

FIGS. 17 through 18 illustrate processing flow diagrams that show an example embodiment of an augmented reality process flow as described herein. As part of the augmented reality process flow performed and managed by the location-based community interface processing module 21 and the community processing module 22 for an example embodiment shown in FIG. 17, the client device can determine geographical entities at a location. Then, the client device can upload geographical entities to the server (e.g., host 10). The client device can receive a valid associated Region corresponding to the geographical entities. The client device can receive associated Filter Sets for the Region. The client device can select a Filter Set of the associated Filter Sets for the Region. The client device can transmit information indicative of the Region and Filter Set to the server (e.g., host 10). The client device can receive available Content in that Region with the associated Filter Set. The client device can begin an augmented reality experience based on the available Content in that Region with the associated Filter Set. If the client device and location support GeoTracking, processing continues at the bubble B illustrated in FIG. 18. If the client device and/or location does not support GeoTracking, then a WorldTracking AR Session is initialized and processing continues at the bubble A illustrated in FIG. 18.

Referring to FIG. 18, if the Client device and location support GeoTracking, processing continues at the bubble B. In this case, a GeoTracking AR Session is initialized. GeoTracking-enabled Content automatically renders as the Client device approaches the corresponding geo-location. Rendered Content can be selected (e.g., tapped) to display a UI to interact (e.g., comment, like, dislike, share, report, etc.) with the Content. The User Interface (UI) can display a count and a list of not rendered, renderable Content in proximity to the geo-location. The client device can select the renderable, unrendered Content. The content can be rendered and UI displays can be provided to interact (e.g., comment, like, dislike, share, report, etc.) with the rendered content. The augmented reality process of an example embodiment ends at the End bubble shown in FIG. 18.

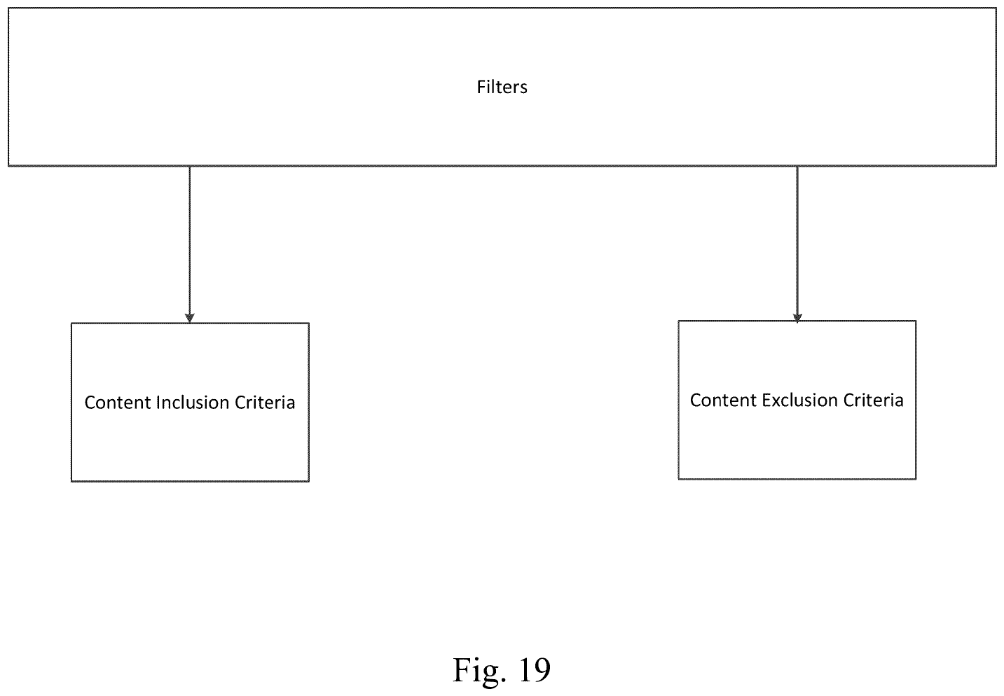

FIGS. 19 through 21 illustrate filter structures used in an example embodiment. As shown in FIG. 19, filters or filter sets can include content inclusion criteria and content exclusion criteria.

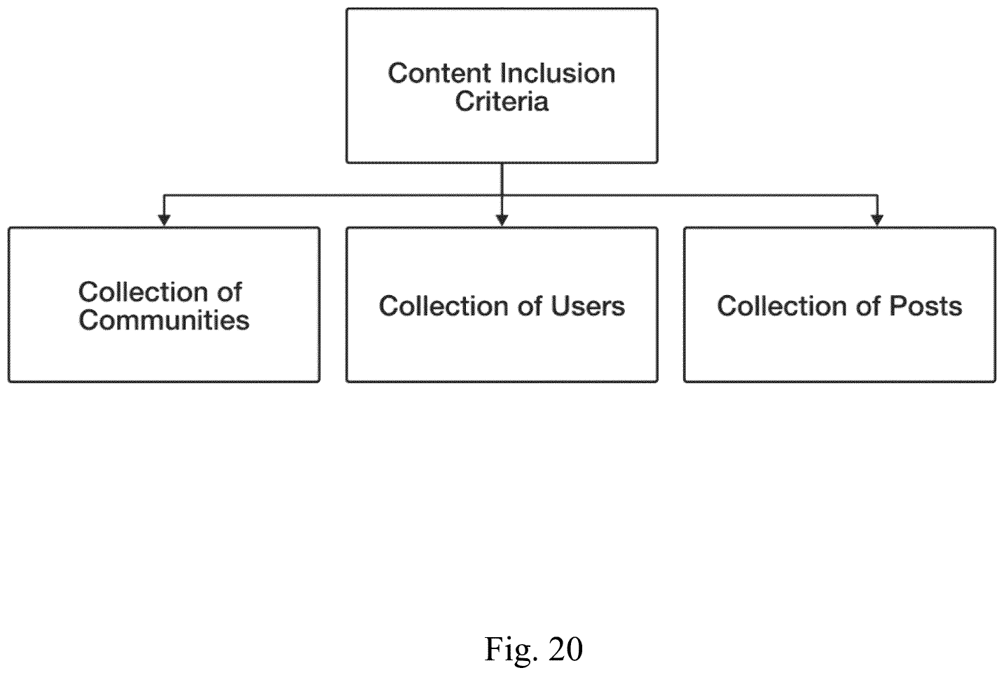

As shown in FIG. 20, the content inclusion criteria for filters or filter sets can include a collection of communities, a collection of users, and a collection of posts.

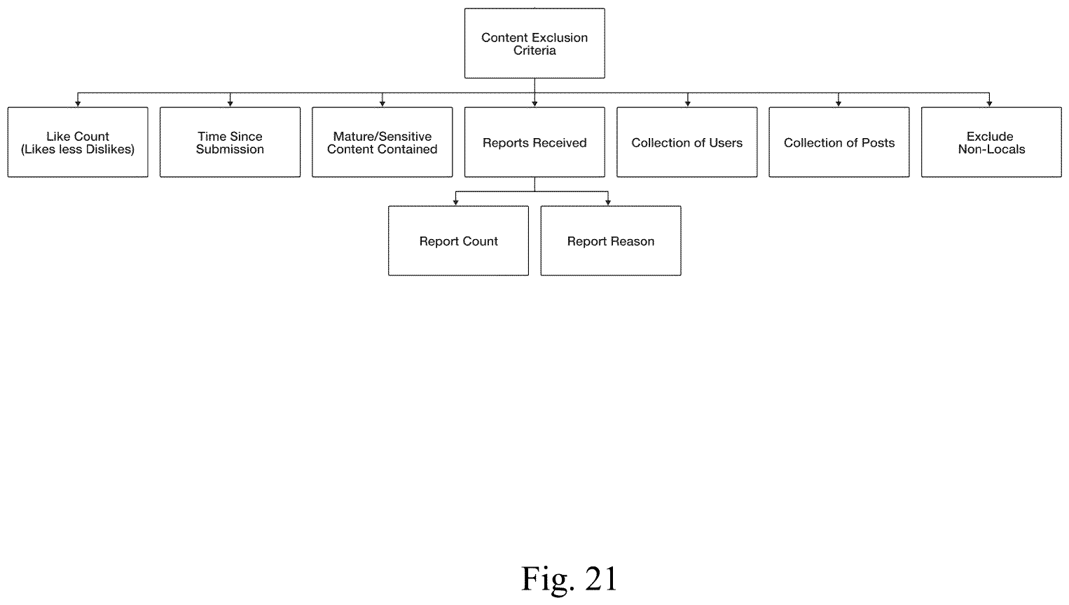

As shown in FIG. 21, the content exclusion criteria for filters or filter sets can include a Like Count (e.g., Likes less Dislikes), an indication of a Time Since Submission, an indication of Mature/Sensitive Content Contained, an indication of Reports Received, a Collection of Users, a Collection of Posts, and information to Exclude Non-Locals. For the indication of Reports Received, the information can include a report count and a report reason.

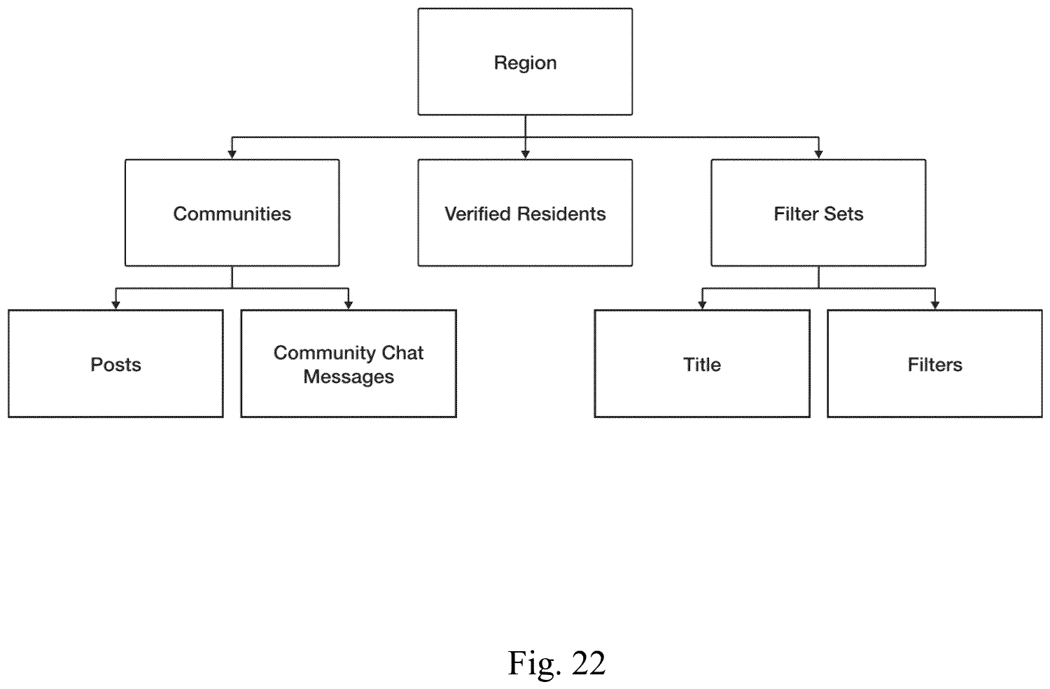

FIG. 22 illustrates region structures used in an example embodiment. As shown, the region structure can include communities, verified residents, and filter sets. Each community can include associated posts and community chat messages. Each filter set can include a filter title and associated filters.

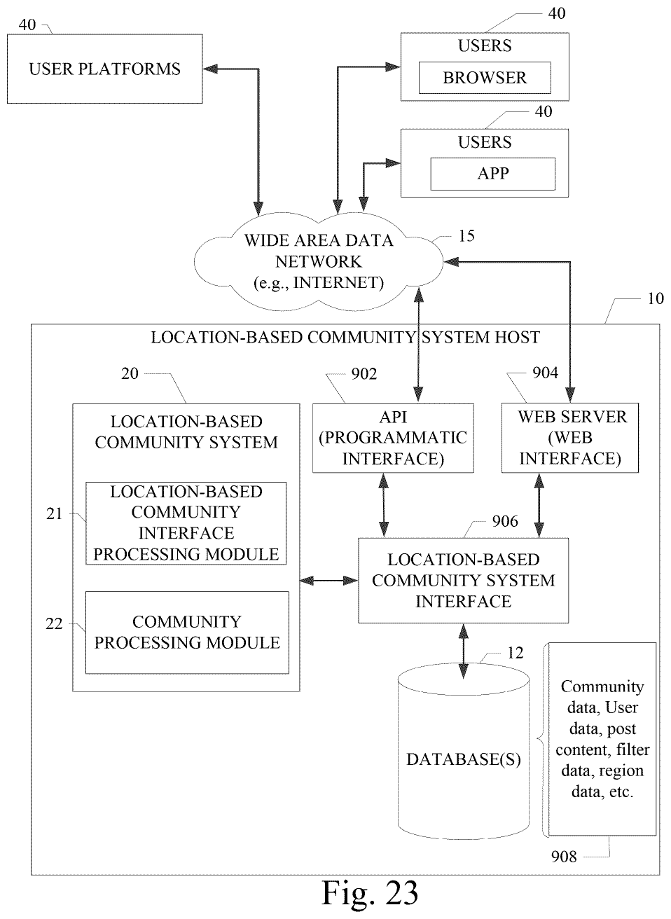

Referring now to FIG. 23, another example embodiment of a networked system in which various embodiments may operate is illustrated. In the embodiment illustrated, the host site 10 is shown to include the location-based community system 20. The location-based community system 20 is shown to include the location-based community interface processing module 21 and a community processing module 22, as described above. In a particular embodiment, the host site 10 may also include a web server 904, having a web interface with which users may interact with the host site 10 via a user interface or web interface. The host site 10 may also include an application programming interface (API) 902 with which the host site 10 may interact with other network entities on a programmatic or automated data transfer level. The API 902 and web interface 904 may be configured to interact with the location-based community system 20 either directly or via an interface 906. The location-based community system 20 may be configured to access a data storage device 12 either directly or via the interface 906.

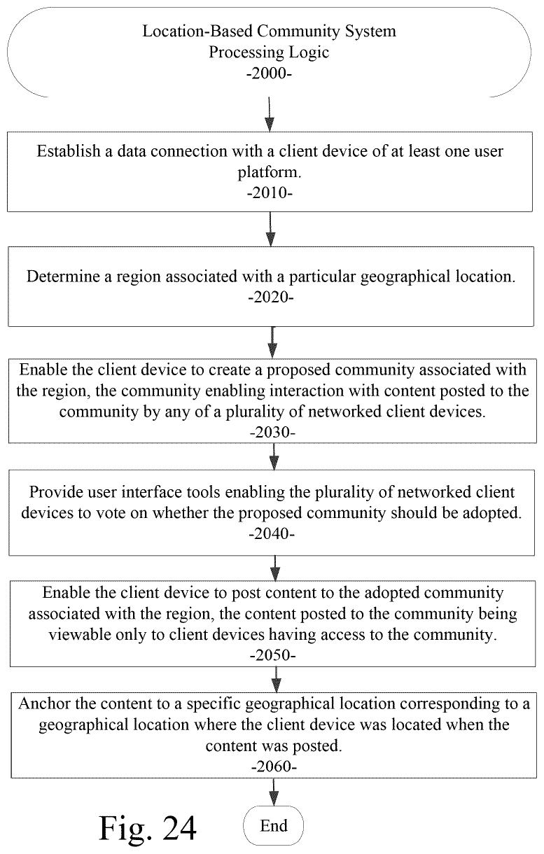

Referring now to FIG. 24, a processing flow diagram illustrates an example embodiment of a method implemented by the location-based community system 2000 as described herein. The method 2000 of an example embodiment includes: establishing a data connection with a client device of at least one user platform (processing block 2010); determining a region associated with a particular geographical location (processing block 2020); enabling the client device to create a proposed community associated with the region, the community enabling interaction with content posted to the community by any of a plurality of networked client devices (processing block 2030); providing user interface tools enabling the plurality of networked client devices to vote on whether the proposed community should be adopted (processing block 2040); enabling the client device to post content to the adopted community associated with the region, the content posted to the community being viewable only to client devices having access to the community (processing block 2050); and anchoring the content to a specific geographical location corresponding to a geographical location where the client device was located when the content was posted (processing block 2060).

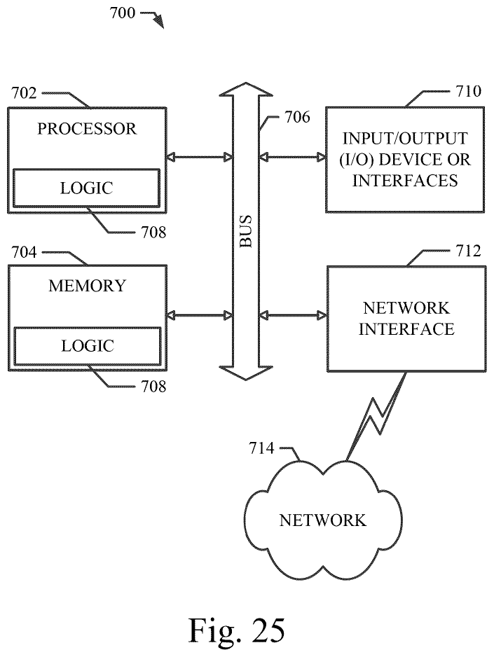

FIG. 25 shows a diagrammatic representation of a machine in the example form of a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a mobile device, a web appliance, a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, 5th (5G) generation and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE 802.11x, and the like. In essence, network interface 712 may include or support virtually any wired and/or wireless communication mechanisms by which information may travel between the mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that stores the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

In various example embodiments described herein, a system and method for creating and using a location-based augmented reality community platform are disclosed. In the various example embodiments described herein, a computer-implemented tool or software application (app) as part of a location-based community system is described to automate and improve the ability for people with common interests associated with a particular geographic location to communicate and interact. In various example embodiments described herein, the location-based community system provides a series of processes to facilitate a user's ability to search for and connect with people with common interests associated with a particular geographic location. As a result, the described embodiments improve the fields of data communication, network connectivity, network-based searchability, and provide an improved ability for people with common interests associated with a particular geographic location to connect.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method comprising:
establishing, by use of a data processor and a data network, a data connection with a client device of at least one user platform;
determining, by use of the data processor, a region associated with a particular geographical location;
enabling the client device to create a proposed community associated with the region, the community enabling interaction with content posted to the community by any of a plurality of networked client devices;
providing user interface tools enabling the plurality of networked client devices to vote on whether the proposed community should be adopted;
enabling the client device to post content to the adopted community associated with the region, the content posted to the community being viewable only to client devices having access to the community; and
anchoring the content to a specific geographical location corresponding to a geographical location where the client device was located when the content was posted.

2. The method of claim 1 wherein only ones of the plurality of networked client devices having verified resident status are enabled to vote on the proposed community.

3. The method of claim 1 wherein the region is determined based on existing hierarchically nested geographical entities.

4. The method of claim 1 wherein verified resident status can be achieved after the client device uses a location-based community application for a pre-determined number of different days within a pre-determined time period from within the region.

5. The method of claim 1 further including enabling the client device to create a filter set associated with the region, the filter set including content inclusion criteria or content exclusion criteria, the filter set being sharable among a plurality of client devices having access to the region.

6. The method of claim 1 further including rendering the content in an augmented reality experience at the anchored location.

7. The method of claim 6 further including enabling the content to be transformed, including translation, rotation, and scaling.

8. The method of claim 1 further including displaying a map showing geographic locations associated with posted content that are located proximate to a location of the client device.

9. The method of claim 1 further including enabling the client device to like, dislike, comment, or report on the posted content.

10. The method of claim 1 further including enabling the community to host a digital marketplace, the marketplace being accessible only to client devices having access to the community.

11. The method of claim 1 further including enabling the community to access live audio or video streams, the live audio or video streams being accessible only to client devices having access to the community.

12. A system comprising:
a data processor;
a network interface, in data communication with the data processor, for communication on a data network; and
a location-based community system, executable by the data processor, to:
establish, by use of the data processor and the data network, a data connection with a client device of at least one user platform;
determine, by use of the data processor, a region associated with a particular geographical location;
enable the client device to create a proposed community associated with the region, the community enabling interaction with content posted to the community by any of a plurality of networked client devices;
provide user interface tools enabling the plurality of networked client devices to vote on whether the proposed community should be adopted;
enable the client device to post content to the adopted community associated with the region, the content posted to the community being viewable only to client devices having access to the community; and
anchor the content to a specific geographical location corresponding to a geographical location where the client device was located when the content was posted.

13. The system of claim 12 wherein only ones of the plurality of networked client devices having verified resident status are enabled to vote on the proposed community.

14. The system of claim 12 wherein the proposed community can be designated as public or private.

15. The system of claim 12 wherein verified resident status can be achieved after the client device uses the location-based community system for a pre-determined number of different days within a pre-determined time period from within the region.

16. The system of claim 12 being further configured to enable the client device to create a filter set associated with the region, the filter set including content inclusion criteria or content exclusion criteria.

17. The system of claim 12 being further configured to render the content in an augmented reality experience at the anchored location.

18. The system of claim 17 being further configured to enable the content to be transformed, including translation, rotation, and scaling.

19. The system of claim 12 being further configured to display a map showing geographic locations associated with posted content that are located proximate to a location of the client device.

20. The system of claim 12 wherein the community is only accessible to client devices physically present in the associated region.

21. A non-transitory machine-useable storage medium embodying instructions which, when executed by a machine, cause the machine to:
establish, by use of a data processor and a data network, a data connection with a client device of at least one user platform;
determine, by use of the data processor, a region associated with a particular geographical location;
enable the client device to create a proposed community associated with the region, the community enabling interaction with content posted to the community by any of a plurality of networked client devices;
provide user interface tools enabling the plurality of networked client devices to vote on whether the proposed community should be adopted;
enable the client device to post content to the adopted community associated with the region, the content posted to the community being viewable only to client devices having access to the community; and
anchor the content to a specific geographical location corresponding to a geographical location where the client device was located when the content was posted.

22. The non-transitory machine-useable storage medium of claim 21 being further configured to render the content in an augmented reality experience at the anchored location.

23. The non-transitory machine-useable storage medium of claim 21 wherein only ones of the plurality of networked client devices having verified resident status are enabled to vote on the proposed community.
